(19) United States
(12) Patent Application Publication
(10) Pub. No.: US 2012/0166346 A1
(43) Pub. Date: Jun. 28, 2012

(54) INTEGRATED METHODS AND SYSTEMS FOR VEHICLE INSPECTION REPORTING AND HOURS OF SERVICE COMPLIANCE

(75) Inventors: HASS MACHLAB, Coralville, IA (US); MARK BROWN, Iowa City, IA (US); HEATHER HUGHES, Coralville, IA (US); KIRK TIMMER-HACKERT, Coralville, IA (US)

(73) Assignee: INNOVATIVE SOFTWARE ENGINEERING, Coralville, IA (US)

(21) Appl. No.: 12/977,337

(22) Filed: Dec. 23, 2010

(51) Int. Cl. G06Q 10/00

(52) U.S. Cl. 705/317

(57) ABSTRACT

A system for electronic driver logs and electronic vehicle inspection reporting includes an onboard computer associated with a vehicle and operatively connecting to and configured to acquire data from a vehicle interface, a driver interface, and a geolocation device. The system has a first software component stored on a computer readable storage medium of the onboard computer providing instruction for receiving input from the user through the driver interface, receiving input from the vehicle interface, and receiving input from the geolocation device and determining compliance with driver regulations based on the data. The system also has a second software component stored on the computer readable storage media of the onboard computer providing instructions for receiving vehicle inspection input from the driver through the driver interface.

### FIELD OF THE INVENTION

The present invention generally relates to vehicle inspection reporting and/or hours of service regulations. More particularly, but not exclusively, the present invention relates to an integrated solution to be used by commercial motor vehicle (CMV) drivers and motor carriers to maintain one or both types of these records electronically, through a seamless user interface that facilitates compliance with regulations.

### BACKGROUND OF THE INVENTION

The background of the invention is discussed in the context of an integrated solution for electronic driver logs with hours of service calculation and driver vehicle inspection reports. The present invention is not to be limited to this specific context.

In the United States, some CMV drivers are required to comply with vehicle inspection reporting and/or hours of service regulations. The purpose of these regulations is to facilitate road safety by ensuring proper vehicle maintenance and reducing driver fatigue. The regulations call for keeping specific records (e.g. driver vehicle inspection reports and driver logs) to facilitate and demonstrate compliance.

Drivers subject to DVIR regulations are required to prepare a DVIR for each vehicle operated during the day. Typically, a DVIR includes:
An identification of the vehicle, such as the truck and/or trailer vehicle or license numbers.
A list of any defects or deficiencies which could affect vehicle safety or result in a breakdown, if any.
An indication that no defect or deficiency was discovered, if such is the case.
Up to three signatures, namely:
   Signature of the driver who prepared the report; in team operations, only one driver must sign as long as all drivers agree to the report contents. This is the only signature required if no defects are noted.
   If a defect is noted, a signature of a mechanic or other person to indicate the vehicle has been repaired or that repairs are unnecessary. This signature appears on the original DVIR and all copies. If the vehicle is repaired en route, the driver or repair facility can sign the DVIR.
   If a defect was noted, signature of the next driver of the vehicle is provided, to indicate that the driver has reviewed the DVIR and is satisfied that the vehicle is in safe operating condition.

The motor carrier may be required to keep the original DVIR for 90 days from the date it was prepared.

Drivers subject to hours of service (HOS) regulation are restricted as to when they can drive, based on how much time a driver has worked or driven since his or her last rest. These drivers also are required to keep a log, or record off duty status for each day. The log typically includes:
All time, using one of the following duty status designations: off duty, sleeper berth, driving, or on duty (not driving).
The location of every status change.
Additional details such as the date, driver's identity, vehicle, distance driven, or motor carrier.

The motor carrier may be required to keep the driver log for six months from the date of the log. In the absence of electronic solutions for driver recordkeeping, drivers subject to DVIR and/or HOS regulation are required to keep handwritten records. Separate pre-printed forms are commonly used for each type of record.

More recently, electronic driver recordkeeping has provided an alternative to handwritten records. Relevant regulations specify certain minimal capabilities and properties of a compliant electronic logging system. These include means for enforcement personnel to review recent EDLs on the on-vehicle system (such as would be used in roadside inspection), means to obtain EDLs from the office system, that the records are tamper-proof, and that records of data corrections and edits are kept and displayed.

Some EDL implementations incorporate computer-assisted calculations for the HOS rules to determine when and how long a driver must rest before operating a CMV. Though not actually a regulatory requirement for compliant solutions, an HOS calculator provides the means to determine driver availability, identify whether violations have occurred, and warn of impending violations. Some electronic recordkeeping systems may place undue burdens on a driver which reduce the likelihood that drivers will properly use the electronic recordkeeping system.

Despite advances in electronic recordkeeping association CMVs, problems remain. What is needed are systems and methods for vehicle inspection reporting and/or hours of service regulation compliance having the advantage of providing an integrated solution to be used by CMV drivers and motor carriers to maintain one or both types of these records electronically, through a seamless user interface that facilitates compliance with regulations.

### BRIEF SUMMARY OF THE INVENTION

Therefore it is a primary, object, feature, or advantage of the present invention to improve over the state of the art.

It is a further object, feature, or advantage of the present invention to provide an integrated solution for electronic driver logs with hours of service calculation and driver vehicle inspection reports.

It is another object, feature, or advantage of the present invention to provide streamlining the heretofore separate tasks of recording EDLs and DVIRs in a unique way that supports natural workflow while compelling compliance with recordkeeping rules.

Yet another object, feature, or advantage of the present invention is to provide a common driver interface for DVIR and EDL recording that requires drivers to complete prepare and review inspection reports at appropriate times.

A further object, feature, or advantage of the present invention is to ensure that time a driver spends preparing and/or reviewing a DVIR is properly recorded as On Duty time for that driver.

A still further object, feature, or advantage of the present invention is to provide the host interface provides a means for users to see and to work with HOS and/or DVIR records in a manner befitting their role with the motor carrier.

It is another object, feature, or advantage of the present invention to provide integrated record keeping between an EDL (Electronic Drivers Log) and a DVIRs (Driver Vehicle Inspection Report). The Driver can record to an EDL and electronic DVIR in a single operation, yet each record is stored separately and retained in accordance with different rules.

Yet another object, feature, or advantage of the present invention is to provide the Customer the ability to change the user interface. The mobile and host applications support style sheets which enable the customer to change the interface appearance. The Customer can also configure specific content, e.g., categories of defects and commonly noted descriptions.

A further object, feature, or advantage of the present invention is to provide the Customer the ability to change the reporting criteria. The Customer can specify items to be included in the vehicle inspections and reports. The Customer can also designate where drivers are based and where equipment is housed and/or serviced to aid with record selection. Customer can further assign custom user roles to control host-side access to driver records.

A still further object, feature, or advantage of the present invention is to provide a method to update software over the air remotely. This allows for wireless deployment of latest mobile software code.

Another object, feature, or advantage of the present invention is to provide a system which is modular and expandable. Applications can be added to the system as needed. The Customer can enable only the applications they need.

Another object, feature, or advantage of the present invention is to provide a system which may be rapidly integrated with other software systems. This provides seamless integration with the customer or third party software. The end user may be unaware that ISE solution was not co-developed with other applications.

Another object, feature, or advantage of the present invention is to provide a system which is hardware independent. The system may be used with a number of off-the-shelf handheld computers, fixed displays and OBCs (on-board computer) with built-in display.

Another object, feature, or advantage of the present invention is to provide a system which is adaptable to fulfill state-specific regulations and/or international regulations which allows for use in intrastate and global commerce.

Another object, feature, or advantage of the present invention is to provide a system which complies with Federal DOT Hours of Service regulations per 49 CFR 395, hours of service of drivers. And the Use of Automatic On-Board Recorders as defined by §395.15: Automatic on-board recording devices per Use of Electronic On-Board Recorders by §395.16.

Another object, feature, or advantage of the present invention is to provide a system which is compliant with the requirements of §395.15 and §395.16 and to calculate availability and violations per the regulations of §395.

Another object, feature, or advantage of the present invention is to provide a system which complies with Federal vehicle inspections are regulated per 49 CFR 396, Inspection, repair, and maintenance. Driver vehicle inspection reporting is defined by §396.11: Driver vehicle inspection report(s) and §396.13: Driver inspection.

Another object, feature, or advantage of the present invention is to provide a system which complies with Federal with the requirements of §395.11 and §395.13 and to calculate availability and violations per the regulations of §395.

Yet another object, feature, or advantage of the present invention is to provide XML messages from an on-board computer over a communications network to provide data for use in determining hours of service compliance or vehicle inspection compliance.

A still further object, feature, or advantage of the present invention is to allow for determining compliance both of a vehicle as well of a remote location.

It is another object, feature, or advantage of the present invention to provide wireless synchronization of electronic data between mobile and host system.

Yet another object, feature, or advantage of the present invention is to provide portability of EDLs and DVIRs from mobile to host, host to mobile, and mobile to mobile via memory device (e.g., USB flash drive).

A further object, feature, or advantage of the present invention is to provide support for team driver operations and slip seating.

A still further object, feature, or advantage of the present invention is to provide automated odometer capture.

Another object, feature, or advantage of the present invention is to provide automated location capture based on GPS data.

Another object, feature, or advantage of the present invention is to provide OBC failure detection and reporting.

Another object, feature, or advantage of the present invention is to provide on-board viewing of EDLs and DVIRs to support roadside inspection.

Another object, feature, or advantage of the present invention is to provide host-side viewing and printing of EDLs, DVIRs and other reports to support DOT and internal audits.

Yet another object, feature, or advantage of the present invention is to provide on-board recording of vehicle identification.

A still further object, feature, or advantage of the present invention is to provide on-board recording of defects.

Another object, feature, or advantage of the present invention is to provide electronic signature capture for each of the following, (1) Post-trip or pre-trip report creation (mobile), (2) Certification that repairs were made or are not needed for operation (host or mobile), (3) Pre-trip driver indication of safe operating condition of vehicle (mobile).

It is another object, feature, or advantage of the present invention to provide on-board recording of duty status with automated Driving detection based on vehicle motion and rest.

Yet another object, feature, or advantage of the present invention is to provide on-board duty status locking (manual override of automated Driving detection).

A further object, feature, or advantage of the present invention is to provide pre sign in and post sign out recording of On Duty status (for documenting time worked away from vehicle).

A still further object, feature, or advantage of the present invention is to provide driving and on duty time calculations made independently on the mobile and on the host.

Another object, feature, or advantage of the present invention is to provide on-board audio and visual warnings for low availability and violation.

Another object, feature, or advantage of the present invention is to provide support for split sleeper periods in calculations.

Another object, feature, or advantage of the present invention is to provide support for temporary exemptions from HOS regulation.

Another object, feature, or advantage of the present invention is to provide host-side discrepancy detection (to aid in finding and correcting incorrect entries).

Another object, feature, or advantage of the present invention is to provide host-side editing of driver logs with marking and tracking of edits per regulation.

One or more of these and/or other objects, features, or advantages of the present invention will become clear from the specification and claims that follow. No single embodiment need exhibit each and every object, feature, or advantage.

According to one aspect of the present invention, a system for electronic driver logs and electronic vehicle inspection reporting is provided. The system includes an onboard computer associated with a vehicle and operatively connecting to and configured to acquire data from a vehicle interface, a driver interface, and a geolocation device. The system further includes a first software component stored on a computer readable storage medium of the onboard computer providing instruction for receiving input from the user through the driver interface, receiving input from the vehicle interface, and receiving input from the geolocation device and determining compliance with driver regulations based on the data. The system further includes a second software component stored on the computer readable storage media of the onboard computer providing instructions for receiving vehicle inspection input from the driver through the driver interface.

According to another aspect of the present invention, a method for monitoring hours of service compliance data and vehicle inspection data is provided. The method includes providing a system comprising an onboard computer associated with a vehicle and operatively connecting to and configured to acquire data from a vehicle interface, a driver interface, and a geolocation device. There is a first software component stored on a computer readable storage medium of the onboard computer providing instruction for receiving input from the user through the driver interface, receiving input from the vehicle interface, and receiving input from the geolocation device and determining compliance with driver regulations based on the data. There is a second software component stored on the computer readable storage media of the onboard computer providing instructions for receiving vehicle inspection input from the driver through the driver interface. The method further includes receiving from the driver data for use in determining compliance with hours of service regulations and data for documenting a vehicle inspection performed by the driver and storing on a computer readable storage media the data for use in determining compliance with hours of service regulations and the data for documenting a vehicle inspection.

### BRIEF DESCRIPTION OF THE DRAWINGS

FIG. 1 is a block diagram illustrating a system.

FIG. 2 through FIG. 6 illustrate examples of different types of configurations where different types of display computers are used, where onboard computer functionality is standalone or a part of the display computer, and other variations in the configuration, such as the type of display computer used.

FIG. 7 illustrates another example of the system of the present invention.

### DETAILED DESCRIPTION OF THE PREFERRED EMBODIMENT

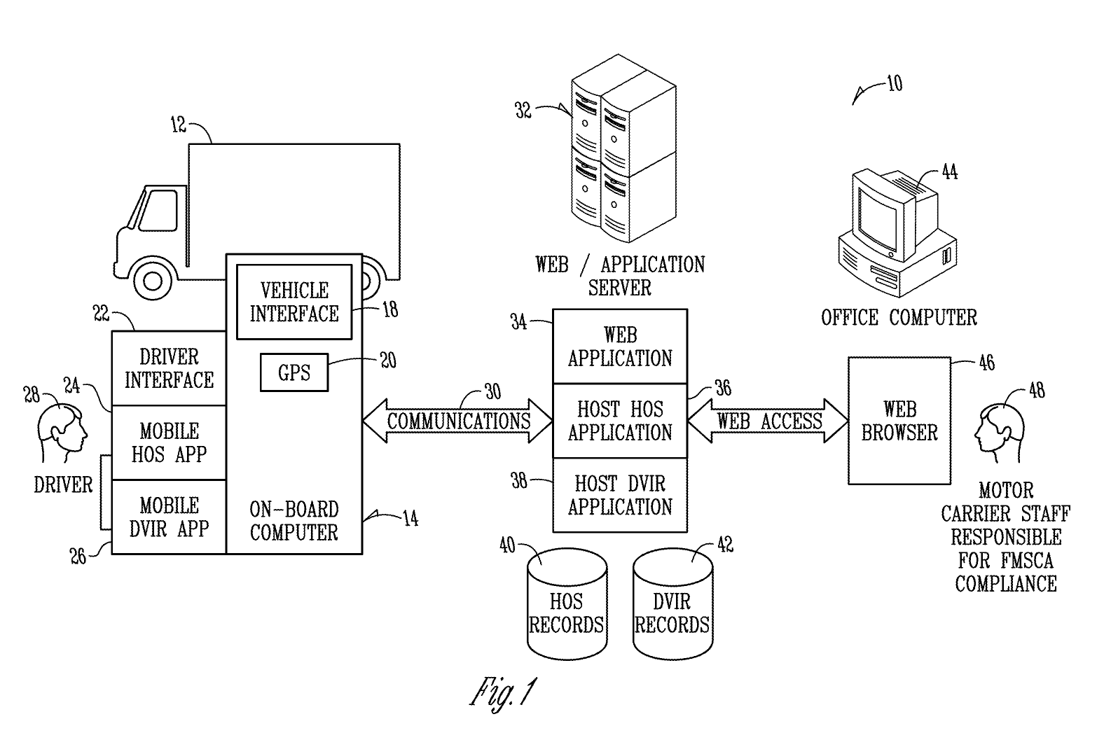

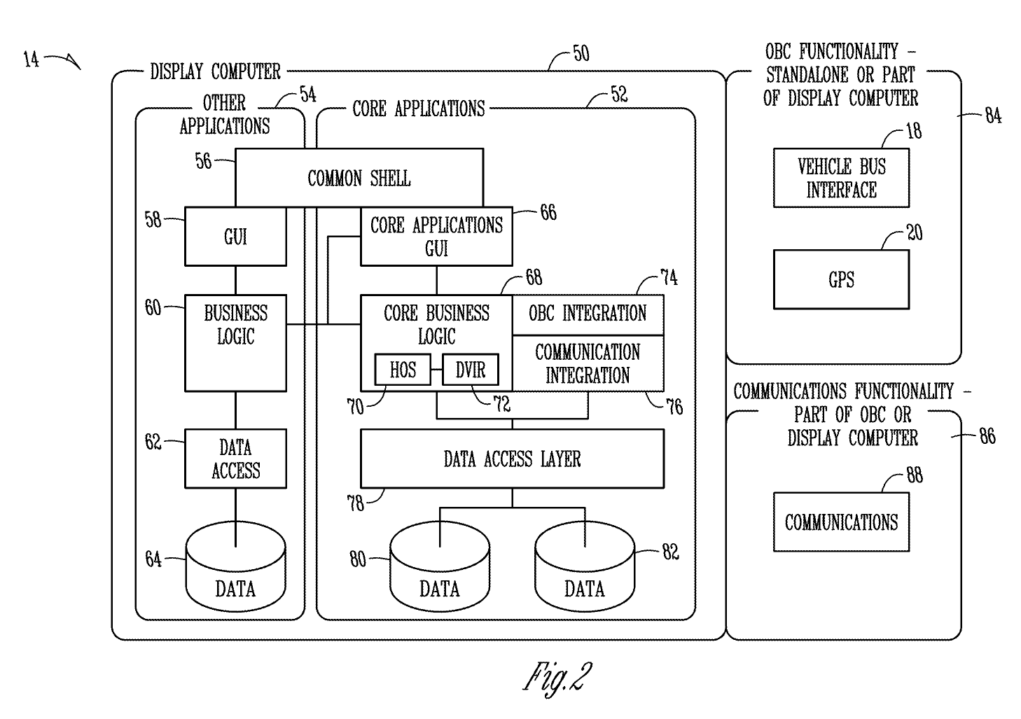

FIG. 1 provides a system overview according to one embodiment. In FIG. 1, a system 10 is provided. A vehicle 12 is shown which has an associated on board computer 14. The onboard computer 14 includes a vehicle interface 18, a location device such as a Global Positioning System (GPS) receiver 20. The GPS receiver 20 allows for automated location capture. The vehicle interface 18 may provide for a number of different functions depending upon the particular implementation. This may include automated odometer capture, determination of when the vehicles is being driven, and other functionality. The determination of when the vehicles is being driven allows for more accurate maintenance of driver logs. This is because an exact time of when the vehicle begins moving and when the vehicle stops moving upon reaching a destination can be recorded and be used in calculating how long a driver has been driving. Thus, on-board recording of duty status with automated driving detection based on vehicle motion and rest may be provided by the onboard computer 14.

The onboard computer 14 also has an associated driver interface which may be implemented with a touchscreen display. The driver 28 of the vehicle 12 may interact with the onboard computer 14 using the driver interface. The onboard computer may also include a mobile hours of service (HOS) application or component 24 and a mobile driver vehicle inspection report (DVIR) application or component 26. Although shown as separate applications in FIG. 1 it is to be understood that a single application may provide both HOS and DVIR functionality. It is noted that currently, federal HOS regulations are provided in 48 CFR §395, herein incorporated by reference. The present invention is preferably compliant with the requirements of 48 CFR §395.15 (Use of Automatic On-Board Recorders) and 48 CFR §395.16 (Use of Electronic On-Board Recorders) as well as to calculate availability and violations per the regulations of 48 CFR §395. In addition, the present invention allows for implementing potential changes in the regulations, regulations in other countries (such as Canada), and state-specific regulations. The present invention further contemplates that a vehicle may be driven throughout different jurisdictions and allows for compliance in each of the jurisdictions during the relevant time period.

With respect to DVIR, in the United States, vehicle inspections are regulated per 49 CFR 396, Inspection, repair, and maintenance. Driver vehicle inspection reporting is defined by 49 CFR §396.11: Driver vehicle inspection report(s) and 49 CFR §396.13: Driver inspection. The invention allows for compliance with the requirements of §395.11 and §395.13 and to calculate availability and violations per the regulations of §395. In addition, the present invention allows for implementing potential changes in these regulations, regulations in other countries (such as Canada), and state specific regulations if application.

The HOS application or component 24 preferably provides support for team driver operations and slip seating. The HOS application or component 24 allows for EDL with HOS calculation capabilities. This may include on-board recording of duty status with automated driving detection based on vehicle motion and rest, on-board duty status locking (manual override of automated driving detection), pre-sign in and post-sign out recording of On Duty status (for documenting time worked away from vehicle), available driving and on duty time calculations made independently on the mobile and on the host, on-board audio and visual warnings for low availability and violation, support for split sleeper periods in calculations, support for temporary exemptions from HOS regulation.

The HOS component 24 further allows for on-board viewing of EDLs and the DVIR component 26 allows for on-board viewing of DVIRs, thus roadside inspection is supported. The onboard computer 14 also provides for on-board recording of vehicle identification and defects.

The onboard computer 14 also allows for electronic signature. Electronic signatures may be captured for post-trip or pre-trip report creation, pre-trip driver indication of safe operating condition of vehicle, certifications that repairs were made or are not needed for operation of the vehicle.

The onboard computer 14 allows for operative communications with a web server or application server 32. These operative communications may be performed over communications channel 30. The communications channel 30 may be of any number of types including cellular-based communications, WiFi communications, satellite communications, or other types of network communications including WWAN or WLAN communications. Use of such communications allows for wireless synchronization of data between the onboard computer 14 and the server 32. In addition, the present invention contemplates that EDLs and DVIRs may be portable such as from mobile to host, host to mobile, and mobile to mobile such as through a memory device (e.g. a USB flash drive or other type of removable memory device).

The server 32 may include a web application 34, a host HOS application 36, and a host DVIR application 38, all stored on a computer readable storage medium. HOS records 40 and DVIR records may be stored in one or more databases and are accessible by the respective applications. The server 32 may be deployed on-site or may be an Application Service Provider (ASP) hosted system.

Other computers such as office computer 44 with a web browser application 46 operating thereon, may access the server 32 through the web or other forms of network communications. This allows motor carrier staff 48 responsible for FMSCA compliance to review records associated with the vehicle 12 and driver 28. Host-side viewing and printing of EDLs, DVIRs and other reports to support DOT and internal audits is thus provided.

In addition various other functionalities associated with HOS or DVIR may be performed through the server 32 (also referred to as “host-side”). For example, the system may allow for host-side discrepancy detection (to aid in finding and correcting incorrect entries) and host-side editing of driver logs with marking and tracking of edits per regulation.

It should further be appreciated that the system shown allows for integration with other systems such as dispatch, driver messaging, timecard/payroll, repair order tracking, and other systems that may be associated with fleet management and related functions. The system also allows for onboard computer failure detection and reporting.

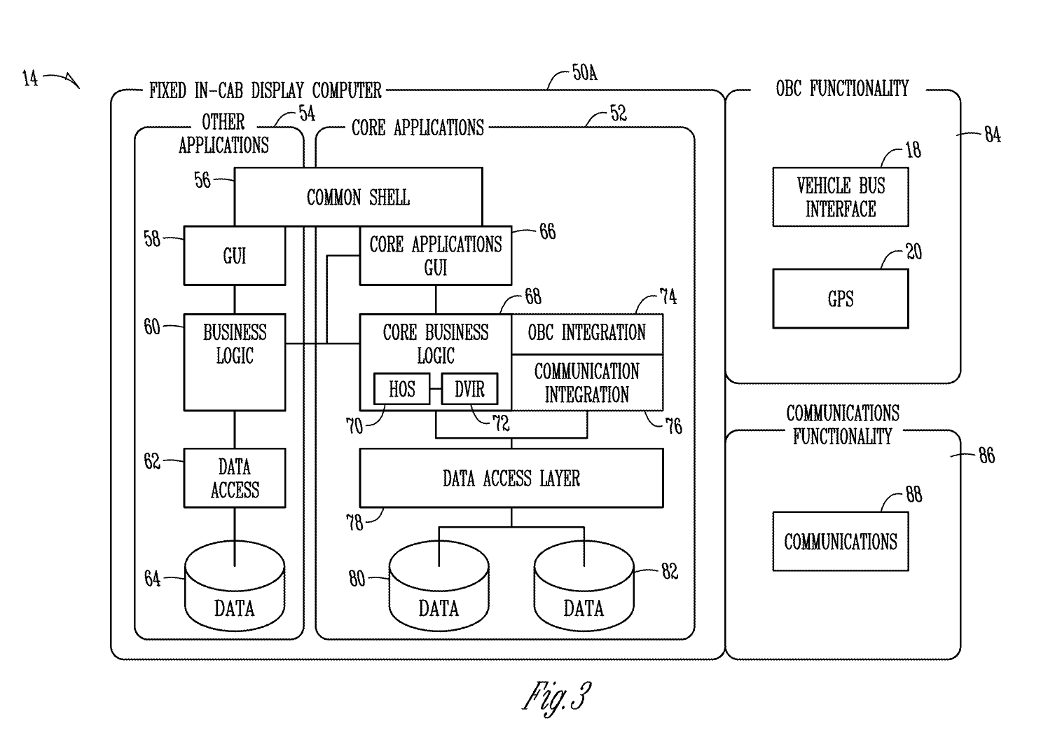

FIG. 2 through FIG. 6 illustrate examples of different types of configurations where different types of display computers are used, where onboard computer functionality is standalone or a part of the display computer, and other variations in the configuration, such as the type of display computer used.

FIG. 2 is a diagram of one embodiment of an entire onboard system (EOBR) 14. Note that in this embodiment a display computer 50 is provided as well as an onboard computer. The OBC may be associated with a vehicle telematics system, a communications system, or other onboard computer. Thus the display computer 50 may be added to an existing system as an overlay or be fully integrated with an existing system where desirable.

Thus, the OBC functionality 84 may be provided by a standalone computer or a portion of the display computer. OBC functionality may include a vehicle bus interface 18 and a GPS receiver 20. Communications functionality 86 may also be provided by a standalone computer or a portion of the display computer. Communications functionality 86 allows for communications 88 to be performed. The communications functionality may be performed over any number of types of communications links or combinations thereof.

The display computer 50 is shown as being programmed to provide core applications 52 as well as other applications 54. The core applications 52 may be partitioned into core components that implant the base EOBR functionality and customizable components that can be used with little or no modification, tailored for a customer's desired look and feel, or incorporated into an existing application suite.

The display computer 50 may operate in a Windows CE or a Windows Mobile or other type of operating system or operating environment. The display computer 50 may be a fixed in-cab computer (with a separate or built-in touch screen display), a portable handheld computer, smartphone, or other mobile device.

The core applications 52 as well as other applications 54 may be executed on the display computer 50. A common shell 56 may be made available both to the core applications 52 as well as the other applications 54. The core applications may have a graphical user interface (GUI) component 66 and a core business logic component 68. The core business logic component 68 may include a HOS component 70 and a DVIR component 72.

The core applications 52 further may include an OBC integration component 74 which may be used to access information associated with the vehicle bus interface 18 and/or GPS 20. In addition, the core applications may include a communication integration component 76.

There is a data access layer 78 provided which allows data 80, 82 to be stored and accessed. The data 80, 82 may be data associated with the HOS and DVIR.

The other applications 54 may have a GUI 58, business logic component 60, a data access component 62, and data 64.

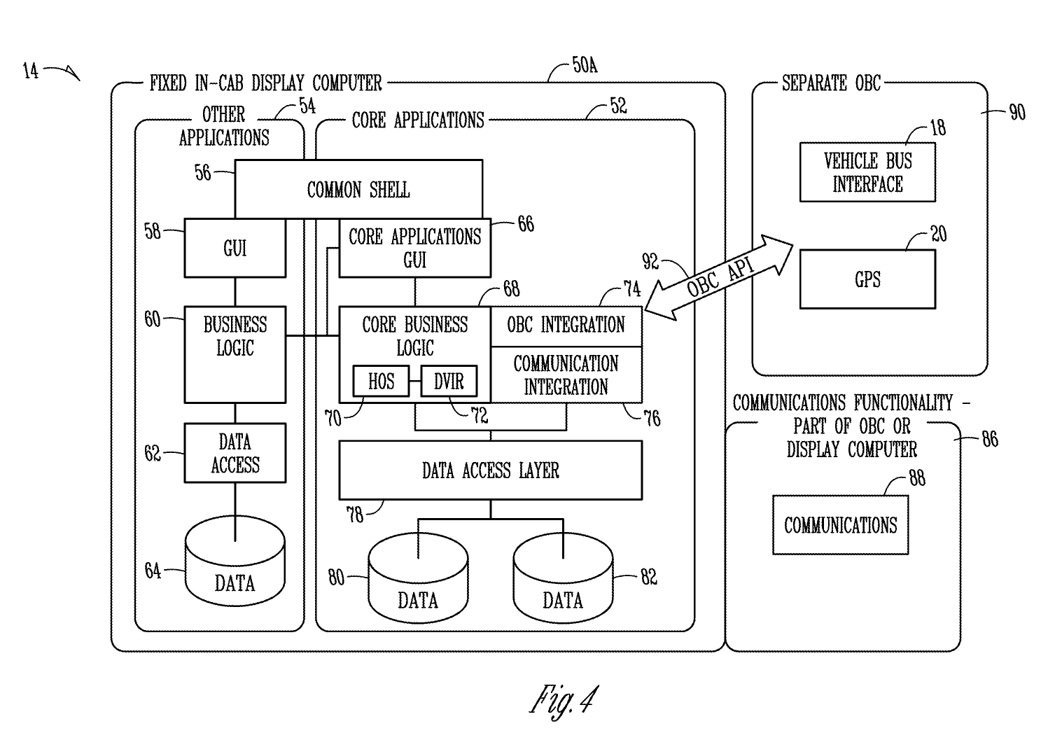

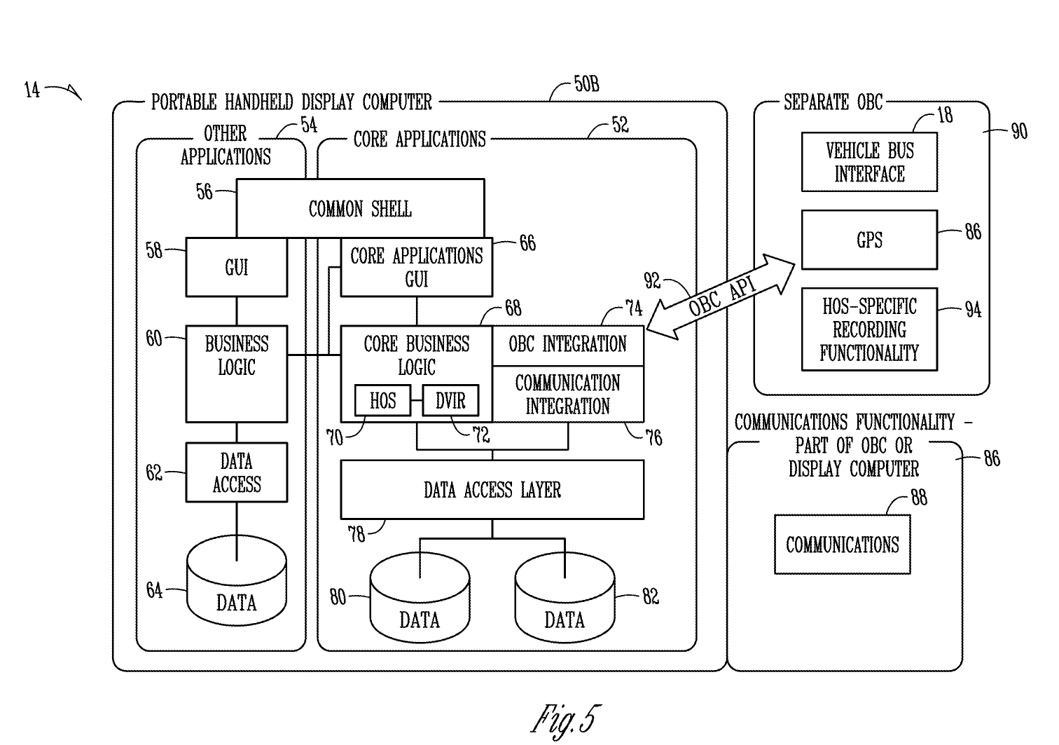

FIG. 3 illustrates an embodiment where the display computer is a fixed-in cab display computer 50A. FIG. 4 illustrates an embodiment where the display computer is a fixed-in cab display computer 50A and where a separate OBC 90 is used to provide the vehicle bus interface 18 and the GPS 20. The OBC integration component 74 communicates using an OBC Applications Programming Interface (API) 92 to communicate with the separate OBC 90. The display computer may communicated with the OBC 90 in various ways such as through serial connections (such as RS-232), Ethernet, or through other type of network connections or interfaces. This may be a wired or wireless communication. Examples of wireless connections which may be used include, without limitation, Wi-Fi or Bluetooth.

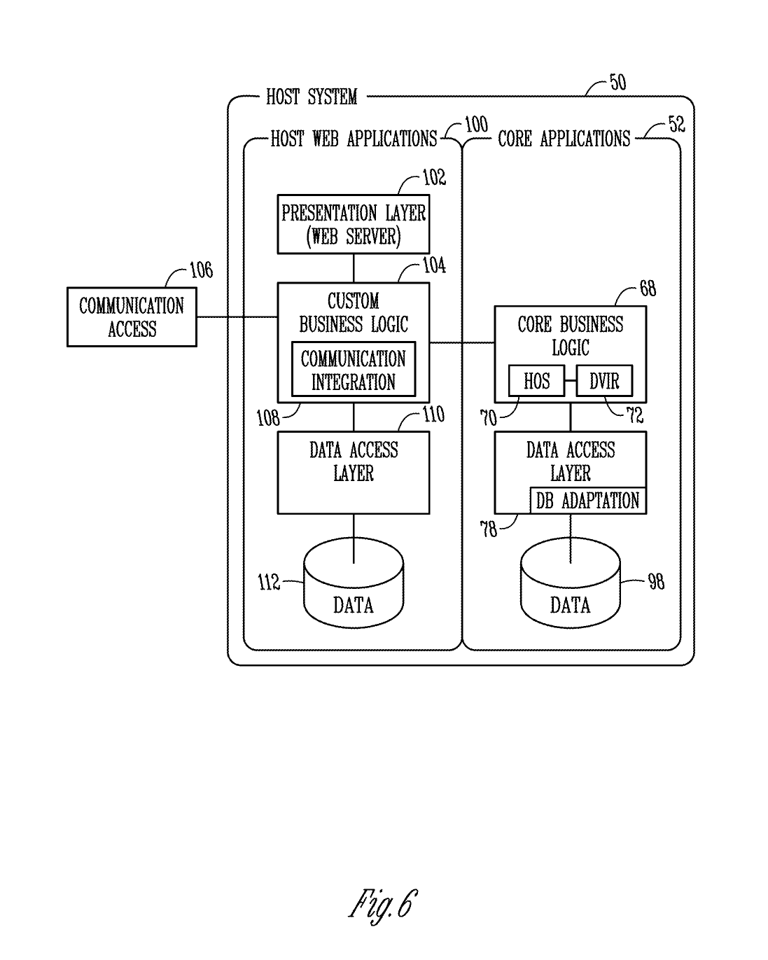

FIG. 5 illustrates an embodiment where the display computer is a portable handheld display computer 50B. As in FIG. 4, a separate OBC 90 is used to provide the vehicle bus interface 18 and the GPS 20. In addition, the separate OBC provides an HOS-specific recording functionality 94.

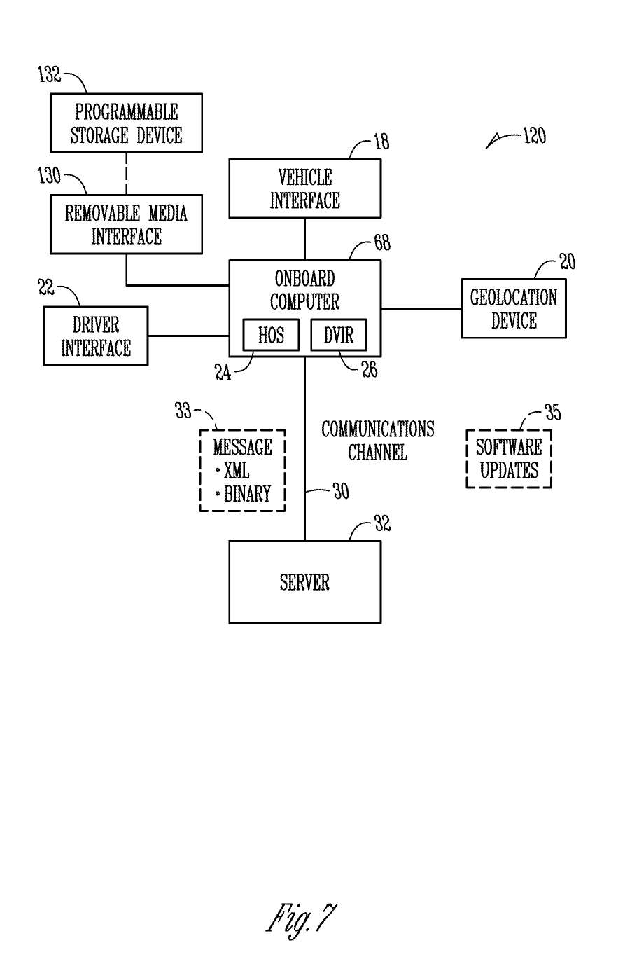

FIG. 6 illustrates another embodiment where the display computer 50 also provides for host web applications 100 as well as core application 52. A presentation layer 102 associated with a web server is shown. Custom business logic 104 is also provided which may include a communication integration component 108 which allows for communication access 106. A data access layer 100 provides access to data 112 which may be stored on a computer readable storage medium.

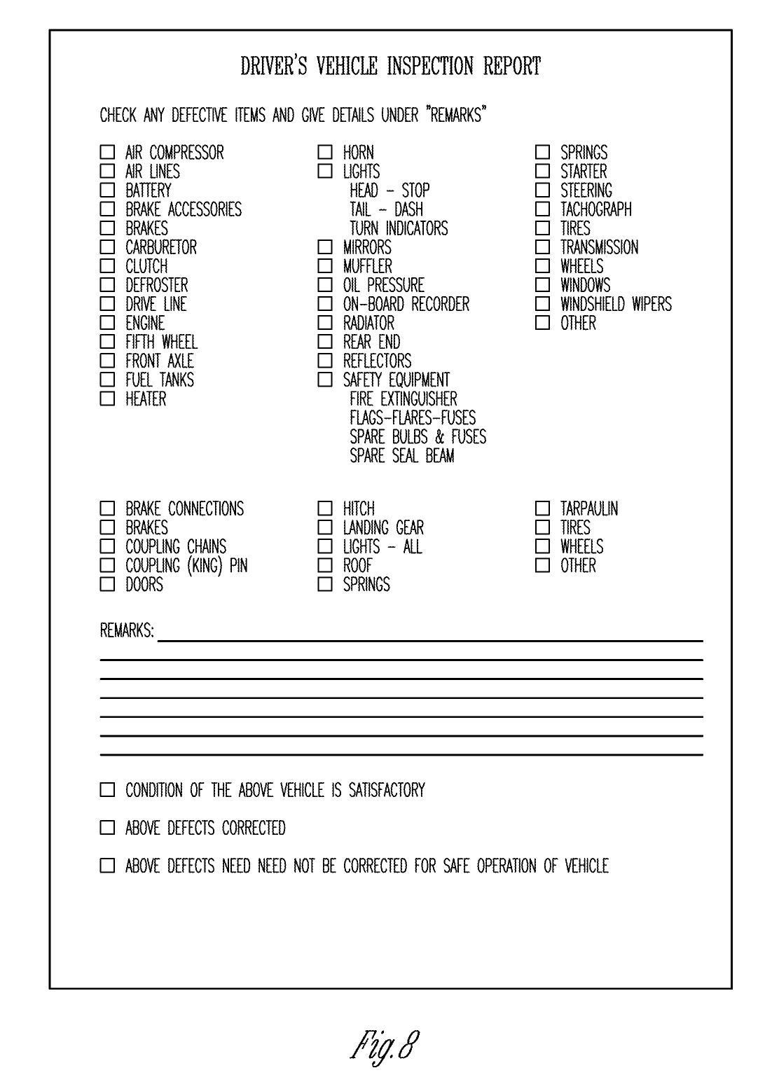

FIG. 7 illustrates another embodiment of a system 120 of the present invention. In the system 120, an onboard computer 14 is provided which has software components executing on it. The software components include an HOS component 24 and a DVIR component 26. The onboard computer 14 may communicate with a server 32 through a communications channel 30.

The onboard computer 14 may communicate information used in the calculation or recording of hours of service as well as vehicle inspection reporting in the form of an XML message 33. The message 33 may include the log date and all events associated with the log date. The server 32 may then use the data to make its own independent calculations associated with hours of service.

A geolocation device 20 is operatively connected to the onboard computer 14. The geolocation device 20 is preferably a GPS receiver, but may be another type of geolocation device. In addition to providing position information, the GPS receiver also provides for exact time. Time and position data may be recorded for use in HOS application as well as for providing additional documentation in the DVIR application.

A driver interface 22 is also operatively connected to the onboard computer 14. The driver interface 22 may include a touch screen display or other type of interface (e.g. a keyboard or keypad) to allow a user to provide input.

A removable storage medium interface 130 is also operatively connected to the onboard computer 14. This allows a driver to convey or communicate data relevant to HOS or DVIR to and from the onboard computer. This is advantageous in situations where network communications are not available between the onboard computer and a host or server 32, such as when outside of a network, when there are network issues, or when there are server issues or other issues. Thus, in these instances, the driver will still be able to have and maintain electronic records relevant to federal regulations, even if they switch vehicles. The removable storage device 132 may be a Universal Serial Bus (USB) device, a memory card, or other type of removable storage device.

The invention has been shown and described above with the preferred embodiments, and it is understood that many modifications, substitutions, and additions may be made which are within the intended spirit and scope of the invention. The present invention is not to be limited to any specific embodiment described herein.

What is claimed is:

1. A system for electronic driver logs and electronic vehicle inspection reporting, the system comprising:
an onboard computer associated with a vehicle and operatively connecting to and configured to acquire data from a vehicle interface, a driver interface, and a geolocation device;
a first software component stored on a computer readable storage medium of the onboard computer providing instruction for receiving input from the user through the driver interface, receiving input from the vehicle interface, and receiving input from the geolocation device and determining compliance with driver regulations based on the data; and
a second software component stored on the computer readable storage media of the onboard computer providing instructions for receiving vehicle inspection input from the driver through the driver interface.

2. The system of claim 1 wherein the onboard computer is configured to communicate over a communications channel with a server.

3. The system of claim 2 wherein the onboard computer provides a XML message over the communication channel.

4. The system of claim 1 further comprising the server, wherein the server being configured to determine compliance with hours of service regulations.

5. The system of claim 1 wherein the first software component comprises a first software application and the second software component comprises a second software application.

6. The communications channel of claim 2 wherein the communication channel is WWAN based.

7. The communications channel of claim 2 wherein the communication channel is WLAN based.

8. The communications channel of claim 6 wherein the communication channel is cellular based.

9. The communications channel of claim 6 wherein the communication channel is satellite based.

10. The system of claim 1 further comprising a removable media interface operatively connected to the onboard computer and configured to allow the onboard computer to read from and write to a removable storage device.

11. A method for monitoring hours of service compliance data and vehicle inspection data, the method comprising:
a) providing a system comprising an onboard computer associated with a vehicle and operatively connecting to and configured to acquire data from a vehicle interface, a driver interface, and a geolocation device,
b) a first software component stored on a computer readable storage medium of the onboard computer providing instruction for receiving input from the user through the driver interface, receiving input from the vehicle interface, and receiving input from the geolocation device and determining compliance with driver regulations based on the data,
c) a second software component stored on the computer readable storage media of the onboard computer providing instructions for receiving vehicle inspection input from the driver through the driver interface;
receiving from the driver data for use in determining compliance with hours of service regulations and data for documenting a vehicle inspection performed by the driver, and
storing on a computer readable storage media the data for use in determining compliance with hours of service regulations and the data for documenting a vehicle inspection.

12. The method of claim 11 wherein data for use in determining compliance with hours of service regulations includes on-board recording of duty status with automated driving detection based on vehicle motion and rest.

13. The method of claim 11 wherein data for use in determining compliance with hours of service regulations includes on-board duty status locking.

14. The method of claim 11 wherein data for use in determining compliance with hours of service regulations includes pre sign in and post sign out recording of On Duty status.

15. The method of claim 11 wherein data for use in determining compliance with hours of service regulations includes available driving and on duty time calculations made independently on the mobile and on the host.

16. The method of claim 11 wherein data for use in determining compliance with hours of service regulations includes on-board audio and visual warnings for low availability and violation.

17. The method of claim 11 wherein data for use in determining compliance with hours of service regulations includes support for split sleeper periods in calculations.

18. The method of claim 11 wherein data for use in determining compliance with hours of service regulations includes support for temporary exemptions from HOS regulation.

19. The method of claim 11 wherein data for use in determining compliance with hours of service regulations includes host-side discrepancy detection.

20. The method of claim 11 wherein data for use in determining compliance with hours of service regulations includes host-side editing of driver logs with marking and tracking of edits per regulation.

21. The method of claim 11 wherein data for documenting a vehicle inspection performed by the driver includes on-board recording of vehicle identification and on-board recording of defects.

22. The method of claim 11 wherein data for documenting a vehicle inspection performed by the driver includes electronic signature capture of at least one of post-trip or pre-trip report creation on mobile device, certification that repairs were made or are not needed for operation on host or mobile device, and pre-trip driver indication of safe operating condition of vehicle on mobile device.

23. The method of claim 11 further comprising displaying an electronic driver log (EDL) on a display associated with the onboard computer.

24. The method of claim 11 further comprising storing on a removable device the data for use in determining compliance with hours of service regulations and the data for documenting a vehicle inspection and communicating the data for use in determining compliance with hours of service regulations and the data for documenting a vehicle inspection over a network to a server.
